(19) United States
(12) Patent Application Publication
(10) Pub. No.: US 2012/0275513 A1
(43) Pub. Date: Nov. 1, 2012

(54) VIDEO ENCODING/DECODING METHOD AND DEVICE

(75) Inventors: Se Yoon Jeong, Daejeon (KR); Hui Yong Kim, Daejeon (KR); Hae Chul Choi, Daejeon (KR); Sung Chang Lim, Daejeon (KR); Ha Hyun Lee, Daejeon (KR); Jin Ho Lee, Daejeon (KR); Suk Hee Cho, Daejeon (KR); Jong Ho Kim, Daejeon (KR); Jin Soo Choi, Daejeon (KR); Jin Woong Kim, Daejeon (KR); Jin Woo Hong, Daejeon (KR)

(73) Assignee: Electronics and Telecommunications Research Instit, Daejeon (KR)

(21) Appl. No.: 13/516,911

(22) PCT Filed: Dec. 17, 2010
(86) PCT No.: PCT/KR2010/009092

§ 371 Date: Jun. 18, 2012

(30) Foreign Application Priority Data
Dec. 18, 2009 (KR) 10-2009-0126614
Feb. 5, 2010 (KR) 10-2010-0010842
Dec. 17, 2010 (KR) 10-2010-0129885

(51) Int. Cl. H04N 7/26

(52) U.S. Cl. 375/240.02; 375/E07.146

(57) ABSTRACT

Disclosed are a video encoding/decoding method and device. The video encoding method may comprise the steps of: establishing an adaptive filter corresponding to the current image; comparing the adaptive filter established in this way with at least one existing adaptive filter contained in a filter list; establishing whether to add the adaptive filter established in the way described to the adaptive filter list, based on the results of the comparison; and encoding the current image by using an adaptive filter contained in the filter list. In this way, encoding efficiency can be improved.

### TECHNICAL FIELD

The present invention relates to a video coding/decoding method and device, and more particularly, to a technique that may determine an adaptive filter desired to be performed on a current video to perform coding.

### BACKGROUND ART

For a next generation video coding, a coding may be performed on an input video using an adaptive filter. In general, as the adaptive filter, an adaptive interpolation filter (AIF) and an adaptive loop filter may be widely used.

The AIF may be used to interpolate a reference video for each frame. In particular, when the AIF is used, a coding device may calculate the adaptive filter in a frame unit or in a slice unit. In addition, the coding device may transmit information about the calculated adaptive filter to a decoding device. Consequently, when a coding bit rate of an entire frame is small, overhead may be increased due to the information about the adaptive filter.

In this instance, the adaptive loop filter may be used to improve an image quality of a restored video. In addition, when the restored video is used as the reference video, the adaptive filer may be also used to improve a coding performance.

In this manner, a filter may be calculated in the frame unit or in the slice unit for a similar purpose to that of the AIF, and information about the calculated filter may be transmitted to the decoding device.

Accordingly, there is a need for a technique that may improve the coding performance even in a case where a bit rate per frame is small, while reducing the overhead occurring due to the information about the adaptive filter.

In addition, in a conventional video device, a coding mode may be fixed in accordance with an applied profile to be used. In this instance, a used frequency of the coding mode may differ depending on characteristics of a video. Thus, when coding mode information, since a coding efficiency is obviously improved, there is a demand for a technique that may improve the coding performance based on the characteristics in which the coding efficiency is obviously improved.

### DISCLOSURE OF INVENTION

### Technical Goals

An aspect of the present invention provides a device and method for performing coding and decoding by determining an adaptive filer desired to be performed on a current video.

### Technical solutions

According to an aspect of an exemplary embodiment, there is provided a video coding method, including: determining an adaptive filter corresponding to a current video; comparing the determined adaptive filter and at least one of an existing adaptive filter included in a filter manager; determining whether to add the determined adaptive filter to the filter manager based on the compared result; and coding the current video using the adaptive filter included in the filter manager.

In this instance, a structure of an instruction of the filter manager may include a type of the instruction to control the determined adaptive filter, a target filter manager, and filter information.

The comparing may compare similarity between the determined adaptive filter and the existing filters using an inner product between the adaptive interpolation filter and the existing adaptive or fixed interpolation filters, a Euclidean distance, a primary norm, and a secondary norm.

The determining of whether to add the determined adaptive filter may add the determined adaptive filter to the filter manager when similarity between the determined adaptive filter and the existing filters does not exist.

The determining of whether to add the determined adaptive filter may include deleting the adaptive filter from the filter manager when the similarity between the determined adaptive filter and the existing filters does not exist.

The video coding method may further include allocating, to each of the filters, an index indicating a used frequency of the filters included in the filter manager, and arranging the filters based on the allocated index.

According to another aspect of an exemplary embodiment, there is provided a video coding method, including: determining an adaptive filter corresponding to a current video; comparing the determined adaptive filter and at least one of an existing adaptive filter included in a filter manager; determining whether to add the determined adaptive filter to the filter manager based on the compared result; coding the current video using the adaptive filter included in the filter manager; and determining a coding mode of the current video using coding information of a previous video. In this instance, the coding information of the previous video may include at least one of a change in the largest coding unit size to be used in the coding of the current video, a change in the smallest coding unit size to be used in the coding of the current video, a change in the largest transforming size to be used in the coding of the current video, and a change in the smallest transforming size to be used in the coding of the current video.

The video coding method may further include determining the coding mode of the current video using a used frequency of a coding mode of a plurality of previous videos.

The video coding method may further include transmitting the coding mode of the current video in a type of an instruction, or inserting the coding mode of the current video to a picture or a slice header to transmit the inserted coding mode.

According to another aspect of an exemplary embodiment, there is provided a video decoding method, including: extracting filter manger information from a bit stream in which a video coding is performed; and adding an adaptive filter corresponding to a current video to a filter manager based on the filter manger information. Here, the filter manager information may include a type of the adaptive filter corresponding to the current video and change information of the filter manager.

The change information of the filter manger may include information indicating that a new adaptive filter is added to the filter manager, information indicating that at least one of the adaptive filters included in the filter manager is deleted, or information indicating that an index of the adaptive filter included in the filter manager is changed.

Also, the adaptive filter may include at least one of an adaptive interpolation filter and an adaptive loop filter, and the filter manager. Also, the filter manager may include at least one of an adaptive interpolation filter manager and an adaptive loop filter manager.

Here, the video decoding method may further include deleting an existing adaptive filter from the filter manager using a used frequency of each of the existing adaptive filters or an FIFO scheme, and decoding the current video using the filters included in the filter manager. In this instance, the adding of the adaptive filter may add the adaptive filter corresponding to the current video to the filter manager after deleting the adaptive filter from the filter manager.

According to another aspect of an exemplary embodiment, there is provided a video decoding method, including: extracting mode information with respect to a current video from a bit stream in which a video coding is performed; and decoding the current video in a coding size corresponding to the mode information. Here, the mode information may include at least one of a change in the largest coding unit size, a change in the smallest coding unit size, a change in the largest transforming size, and a change in the smallest transforming size.

Also, the extracting may receive the mode information with respect to the current video in a type of an instruction, or extract the mode information with respect to the current video inserted into a picture or a slice header.

Also, the mode information may include a coding size determined or changed in a frame unit with respect to the current video, in a Group of picture (GOP) slice, or a macro block unit.

### EFFECTS OF INVENTION

According to an embodiment, it is possible to reduce overhead due to adaptive filter information by managing an adaptive interpolation filter and an adaptive loop filter in a list.

In addition, according to an embodiment, it is possible to improve a coding performance by determining a mode corresponding to a current video. In particular, it is possible to reduce a number of bits indicating coding mode information.

### BRIEF DESCRIPTION OF DRAWINGS

FIG. 1 is a block diagram illustrating a configuration of a video coding device according to an embodiment of the present invention;

FIG. 2 is a diagram illustrating a method of managing an adaptive filter list according to an embodiment of the present invention;

FIG. 3 is a flowchart illustrating a method of managing a filter list in a video coding device according to an embodiment of the present invention;

FIG. 4 is a flowchart illustrating a method of determining a mode in a video coding device according to an embodiment of the present invention;

FIG. 5 illustrates a configuration of a video decoding device according to an embodiment of the present invention; and

FIG. 6 is a flowchart illustrating a video decoding method according to an embodiment of the present invention.

### BEST MODE FOR CARRYING OUT THE INVENTION

Although a few exemplary embodiments of the present invention have been shown and described, the present invention is not limited to the described exemplary embodiments, wherein like reference numerals refer to the like elements throughout.

According to an embodiment of the present invention, a coding unit is defined as a basic unit of coding, and the invention will be described using the coding unit. That is, the coding unit is defined as follows.

A coding and decoding unit when coding and decoding a video may denote a unit, when coding and decoding are obtained by dividing a single video into segmented blocks. For example, the coding unit may be referred to as a macro block or a coding unit.

In describing embodiments illustrated in the drawings, specific terminology is employed for conciseness. However, the invention is not intended to be limited to the specific terminology so selected, and it is to be understood that each specific element includes all technical equivalents that operate in a similar manner to accomplish a similar purpose. Various terms that are used in this specification are to be given their broadest reasonable interpretation when used to interpret the claims.

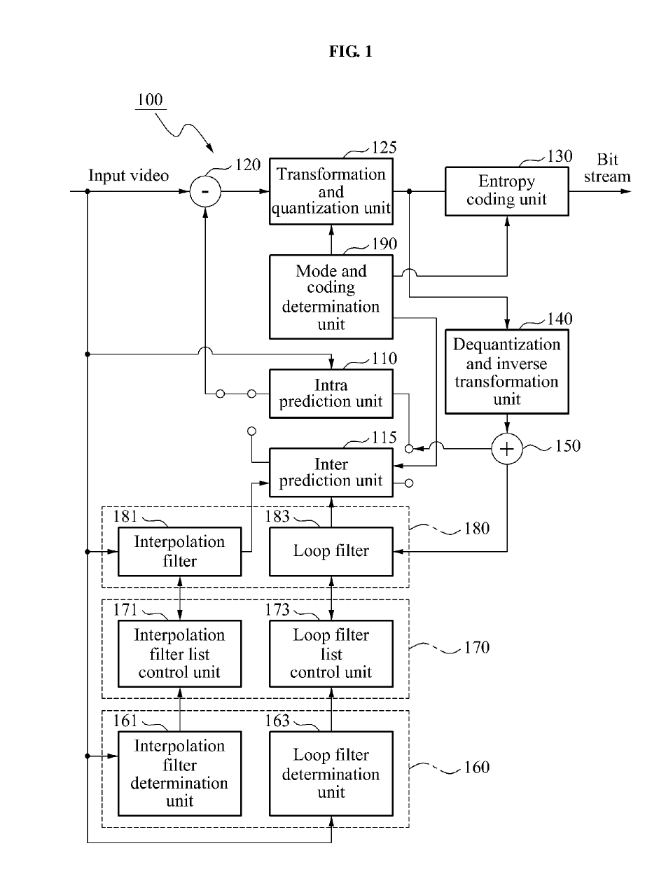

FIG. 1 is a block diagram illustrating a configuration of a video coding device 100 according to an embodiment of the present invention.

Referring to FIG. 1, the coding device 100 according to an embodiment of the invention includes an intra prediction unit 110, an inter prediction unit 115, a difference unit 120, a transformation and quantization unit 125, an entropy coding unit 130, a dequantization unit and inverse transformation unit 140, an adding unit 150, a filter determination unit 160, a filter list control unit 170, an adaptive filter 180, and a mode determination unit 190.

The intra prediction unit 110 may predict a block to be coded using a pixel value of a spatially neighboring pixel so as to code a block of an input video.

That is, the intra prediction unit 110 may generate a prediction block, that is, a prediction value of a current block included in the input video. Here, the input video may include a plurality of coding units.

In addition, the plurality of coding units may respectively include a plurality of sub-blocks.

The inter prediction unit 115 may predict the input video based on coding information of a previous video.

The difference unit 120 may generate a difference block by reducing the prediction block from the current block.

The transformation and quantization unit 125 may perform a Discrete Cosine Transform (DCT) on, and quantize the difference block generated in the difference unit 120 to thereby generate a quantized transformation coefficient. The entropy coding unit 130 may perform entropy-coding on coding information such as the quantized transformation coefficient, a motion vector, and the like. In this instance, the coding information may be inserted to a bit stream to be transmitted to a decoding device.

The dequantization and inverse transformation unit 140 may dequantize the difference block quantized in the transformation and quantization unit 125 so as to use the dequantized difference block for predicting a next video to be coded, and perform an Inverse Discrete Cosine Transform (IDCT) to thereby restore a difference block before the coding is performed.

The adding unit 150 may restore a current block before the coding by adding the restored difference block and the prediction block generated in the intra prediction unit 110.

The filter determination unit 160 may include an interpolation filter determination unit 161 and a loop filter determination unit 163. The filter determination unit 160 may determine an adaptive filter corresponding to an inputted current video.

The interpolation filter determination unit 161 may determine an adaptive interpolation filter by calculating a filter coefficient and a filter tap which correspond to the inputted current video. For example, the interpolation filter determination unit 161 may determine the adaptive interpolation filter corresponding to the current video using a Wiener filter.

The loop filter determination unit 163 may determine an adaptive loop filter by calculating the filter coefficient and the filter tap which correspond to the current video.

For example, the loop filter determination unit 161 may determine the adaptive loop filter corresponding to the current video using the Wiener filter. Here, various methods of determining the loop filter and the interpolation filter which correspond to the current video may exist, and have been already well-known technologies. Thus, a detailed description thereof will be omitted.

The filter list control unit 170 may include an interpolation filter list control unit 171 and a loop filter list control unit 173. Here, the filter list may be merely an example of a filter manager for managing a plurality of filters, and therefore other means or methods other than the filter list may be used so as to manage the plurality of filters.

The filter list control unit 170 may determine whether to add, to the filter list, the adaptive filter corresponding to the current video determined in the filter determination unit 160. In this instance, a structure of an instruction of each of the interpolation and loop filter lists may include a type of the instruction, a target filter list, and filter information as shown in the following Table 1.

TABLE 1

| | | |
|---|---|---|
| Type of instruction | Target filter list | Filter information |

Here, the type of the instruction may include an instruction to add the adaptive filter determined in the filter determination unit 160 to the filter list, an instruction to delete any one of existing adaptive filters included in the filter list, and an instruction to adjust an index of the adaptive filter included in the filter list.

In addition, the filter information may include a size of a filter, a used frequency of the filter, a filter coefficient, a data type of the filter coefficient, and characteristic information of the filter. Here, the characteristic information of the filter may include symmetrical properties of the filter.

More specifically, the interpolation filter list control unit 171 may compare similarity between the adaptive interpolation filter determined in the interpolation filter determination unit 161 and the existing adaptive interpolation filters included in the interpolation filter list. The interpolation filter list control unit 171 may determine whether to add the adaptive interpolation filter to the interpolation filter list based on the similarity. In this instance, in the interpolation filter list, interpolation filters are defined in advance before the coding. That is, when using both the adaptive filter and a fixed filter defined in advance before the cording, a fixed interpolation filter as well as the adaptive interpolation filter may be included in the interpolation filter list.

In this instance, the interpolation filter list control unit 171 may compare similarity between the adaptive interpolation filter corresponding to the current video and the existing interpolation filters using an inner product between the adaptive interpolation filter corresponding to the current video and the existing adaptive or fixed interpolation filters, a Euclidean distance, a primary norm, a secondary norm, and the like.

For example, when using the inner product between the adaptive interpolation filter corresponding to the current video with each of the existing interpolation filters, the interpolation filter list control unit 171 may calculate a normalized inner product between the adaptive interpolation filter corresponding to the current video with the existing interpolation filters.

Next, the interpolation filter list control unit 171 may compare each of the calculated normalized inner products with a reference inner product set in advance.

In this instance, when the calculated normalized inner product is equal to or more than the reference inner product, the interpolation filter list control unit 171 may determine that characteristics of the adaptive interpolation filter corresponding to the current video are similar to characteristics of the existing interpolation filter. That is, when any one of a plurality of normalized inner products is equal to or more than the reference inner product, the interpolation filter list control unit 171 may determine that characteristics of the adaptive interpolation filter corresponding to the current video and that of the existing interpolation filter are similar to each other.

In addition, when all of the calculated normalized inner products are less than the reference inner product set in advance, the interpolation filter list control unit 171 may determine that the characteristics of the adaptive interpolation filter corresponding to the current video is not similar to the characteristics of the existing interpolation filter. That is, the interpolation filter list control unit 171 may determine the adaptive interpolation filter corresponding to the current video to be a new interpolation filter.

Thus, when the characteristics of the adaptive interpolation filter corresponding to the current video and the characteristics of the existing interpolation filter are not similar to each other, the interpolation filter list control unit 171 may add the adaptive interpolation filter corresponding to the current video to the interpolation filter list.

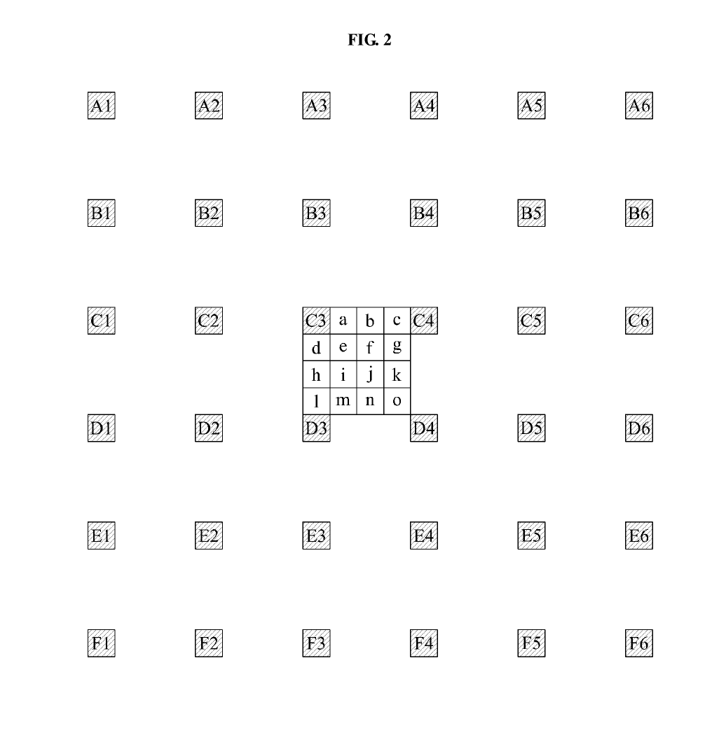

For example, when a target filter list is a sub pixel c of FIG. 2, a size of a filter is 7×7, and the adaptive interpolation filter corresponding to the current video is added to the filter list, a structure of an instruction to add the adaptive interpolation filter to the filter list may be obtained as shown in the following Table 2.

In this instance, in FIG. 2, numbers 1 to 15 may be sequentially allocated to sub pixels a to o in the stated order. Thus, the interpolation filter list control unit 171 may separately manage 15 interpolation filter lists corresponding to the sub pixels a to o.

TABLE 2

| | | |
|---|---|---|
| 1 | 3 | 49 numbered-filter |
| | | information |

Referring to Table 2, the interpolation filter list control unit 171 may calculate normalized inner products between each of the existing adaptive interpolation filters included in the interpolation filter list corresponding to a sub pixel c with the adaptive interpolation filter corresponding to the current video.

Next, when all of the normalized inner products are less than the reference inner product, so that the adaptive interpolation filter corresponding to the current video is not similar to the existing adaptive interpolation filter, the interpolation filter list control unit 171, may add the adaptive interpolation filter corresponding to the current video, to the interpolation filter list corresponding to the sub pixel c.

In this instance, the interpolation filter list control unit 171 may delete any one of the plurality of existing adaptive interpolation filters included in the interpolation filter list, and add the adaptive interpolation filter, corresponding to the current video, to the interpolation filter list.

For example, when a size of the filter list corresponding to the sub pixel c is 4, four existing adaptive interpolation filters are included in the filter list, and the adaptive interpolation filter corresponding to the current video is not similar to the existing adaptive interpolation filter, the interpolation filter list control unit 171 may add the adaptive interpolation filter corresponding to the current video to the filter list by deleting any one of the existing adaptive interpolation filter lists from the filter list.

For this, the interpolation filter list control unit 171 may delete any one of the existing adaptive filters from the interpolation filter list using a First In First Out (FIFO) scheme or based on a used frequency of each of the existing adaptive filters.

For example, using a used frequency of each of the existing adaptive interpolation filters as shown in the following Table 3, the existing adaptive interpolation filter list may be deleted from the interpolation filter list corresponding to the sub pixel c.

TABLE 3

| | | |
|---|---|---|
| 2 | 3 | Fourth filter |

As shown in Table 3, when a used frequency of a filter 4 is the smallest, the interpolation filter list control unit 171 may delete a fourth existing adaptive interpolation filter from among the existing adaptive interpolation filters included in the filter list corresponding to the sub pixel c. Next, when deleting the fourth existing adaptive interpolation filter, the interpolation filter list control unit 171 may add the adaptive interpolation filter, corresponding to the current video, to the interpolation filter list by a structure of an instruction of FIG. 2.

Similarly, when it is necessary to delete the existing adaptive interpolation filter, the interpolation filter list control unit 171 may sequentially delete the existing adaptive filters starting from the existing adaptive filter first added to the interpolation filter list, using the FIFO scheme.

In addition, the interpolation filter list control unit 171 may adjust an index of each of the adaptive interpolation filters included in the interpolation filter list. Here, the index may be information indicating a position of each of the adaptive interpolation filters on the interpolation filter list.

For example, the interpolation filter list control unit 171 may change a position between the adaptive interpolation filters included in the interpolation filter list, by the structure of the instruction work shown in the following Table 4.

TABLE 4

| | | |
|---|---|---|
| 3 | 3 | 0-th filter and fourth filter |

As shown in Table 4, the interpolation filter list control unit 171 may change an index of each of an 0-th filter and a second filter from among the adaptive interpolation filters included in the interpolation filter list corresponding to the sub pixel c. That is, a position of each of the 0-th filter and the second filter may be changed.

In this instance, the interpolation filter list control unit 171 may directly change the position of each of the adaptive filters included in the interpolation filter list, and align the position thereof based on a used frequency.

For example, the interpolation filter list control unit 171 may align the adaptive interpolation filters included in the filter list corresponding to the sub pixel c, in the descending order starting from the adaptive interpolation filter having a large used frequency.

More specifically, the interpolation filter list control unit 171 may allocate a lower index to the adaptive interpolation filter having a larger used frequency to thereby perform alignment in the descending order. In this instance, the interpolation filter list control unit 171 may perform alignment on the interpolation filter list before and after adding the adaptive filter corresponding to the current video to the interpolation filter list.

The adaptive loop filter control unit 173 may compare similarity between the adaptive loop filter corresponding to the current video determined in the loop filter determination unit 163 and each of the existing adaptive loop filters included in the loop filter list. Here, the similarity comparison is the same as that in the adaptive interpolation filter control unit and thus, detailed description thereof will be omitted.

When the adaptive loop filter corresponding to the current video is not similar to each of the existing adaptive loop filters, the loop filter list control unit 173 may add the adaptive loop filter corresponding to the current video to the loop filter list.

In this instance, when a size of the loop filter list is 4, and four existing adaptive loop filters are included in the loop filter list, the loop filter list control unit 173 may delete any one of the existing adaptive loop filters, and add the adaptive loop filter corresponding to the current video to the loop filter list.

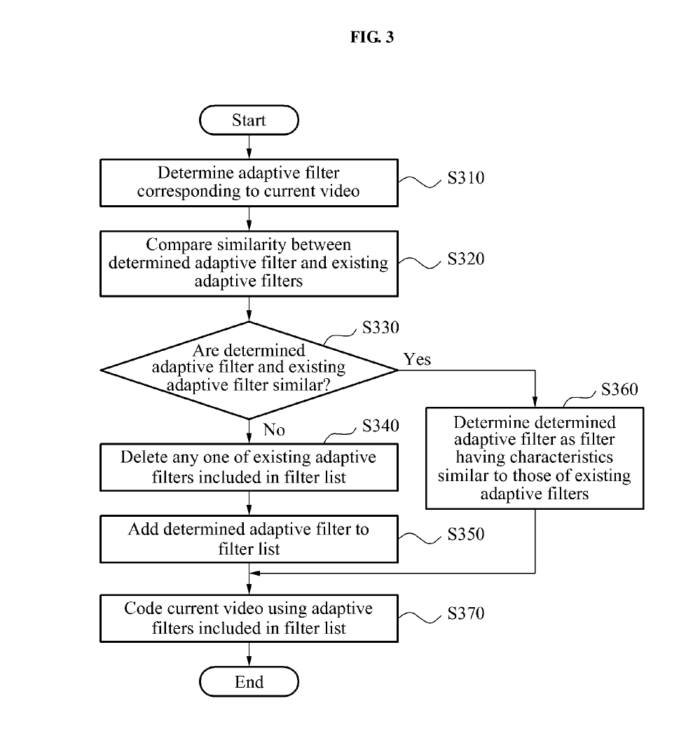

For example, the loop filter list control unit 173 may delete the existing adaptive loop filter from the loop filter list by a structure of an instruction of FIG. 3. In this instance, the loop filter list control unit 173 may delete the existing adaptive loop filters in the descending order of a used frequency of each of the existing adaptive loop filters by counting the used frequency thereof or using the FIFO scheme.

In addition, the loop filter list control unit 173 may add the adaptive loop filter corresponding to the current video to the loop filter list by the structure of the instruction of FIG. 2.

In addition, the loop filter list control unit 173 may adjust an index of each of the adaptive loop filters included in the loop filter list by a structure of an instruction shown in Table 4 to thereby align the adaptive loop filters. Here, operations of the loop filter list control unit 173 are the same as those of the interpolation filter list control unit 171 and thus, detailed description thereof will be omitted.

The adaptive filter 180 may include an interpolation filter 181 and a loop filter 183.

The interpolation filter 181 may code the current video using the adaptive interpolation filters included in the interpolation filter list.

In this instance, when a double pass coding is set in the current video, the interpolation filter 181 may code the current video using the interpolation filter list to which the adaptive interpolation filter corresponding to the current video is added. That is, the interpolation filter 181 may code the current video using the existing adaptive interpolation filters included in the interpolation filter list and the adaptive interpolation filter corresponding to the current video. Here, the double pass coding may denote a case set to enable coding to be performed with respect to the current video at least twice. In this instance, the adaptive filter obtained from the current video may be added to the filter list before decoding the current video. For this, a filter list instruction may be used. Thus, the adaptive interpolation filter obtained from the current video may be used in a decoding process.

In addition, when a single pass coding is set in the current video, the interpolation filter 181 may code the current video using the existing adaptive interpolation filters included in the interpolation filter list before the adaptive interpolation filter corresponding to the current video is added to the interpolation filter list. In this instance, a next video may be coded using the interpolation filter list after the adaptive interpolation filter corresponding to the current video is added to the interpolation filter list.

More specifically, when the single pass coding is set in the current video, the interpolation filter 181 may code the current video using the existing adaptive interpolation filters before the interpolation filter list control unit 171 deletes any one of the existing adaptive interpolation filters. Here, the single pass coding may denote a case set to enable coding to be performed with respect to the current video once.

In this instance, when the double pass coding is set in the current video, and the filter obtained from the current video is added to the filter list, the filter list control unit 171 may enable a filter addition instruction to be included in a coding stream so as to be applied to the current video. Next, a video decoding device may interpret the filter addition instruction to thereby add a corresponding filter to the filter list before decoding the current video.

Next, when the single pass coding is set in the current video, and the filter obtained from the current video is added to the filter list, the filter list control unit 171 may enable the filter addition instruction to be included in the coding stream so as to be applied to videos starting from a subsequent video. Thus, the video decoding device may decode all of the current videos, and then add a corresponding filter to the filter list based on the filter addition instruction. Next, the decoding device may control decoding operations so that a filter application is possible starting from decoding of the subsequent video.

Thus, coding is performed on the current video, and then the interpolation filter list control unit 171 may delete any one of the existing adaptive interpolation filters to thereby add the adaptive interpolation filter corresponding to the current video to the interpolation filter list.

The loop filter 183 may code the current video using loop filters included in the loop filter list.

More specifically, the loop filter 183 may perform coding on the current video including a restored current block using the adaptive loop filters. In this instance, similar to the interpolation filter 181, when the double pass coding is set, the loop filter 183 may code the current video using the existing adaptive loop filters.

In addition, when the single pass coding is set, the loop filter 183 may code the current video using the adaptive loop filter corresponding to the current video and the existing loop filters. Here, the existing loop filters may include fixed loop filters defined in advance before the coding is performed, as well as the adaptive loop filter generated in a process in which the coding is performed. Here, a technique to code the current video using the filter list in accordance with the single pass coding and the double pass coding may be the same as that in the interpolation filter and thus, detailed description thereof will be omitted.

The mode determination unit 190 may determine a coding mode corresponding to the largest coding size of the current video or the smallest coding size of the current video, using coding information of the previous video. Here, the coding information of the previous video may include at least one of change in the largest coding unit size to be used for coding the current video, change in the smallest coding unit size to be used for coding the current video, change in the largest transforming size to be used for coding the current video, and change in the smallest transforming size to be used for coding the current video.

For example, the coding mode corresponding to the coding size may include 4×4, 16×16, 32×32, 64×64, 128×128, and the like. In addition, the coding information of the previous video may include a used frequency of each of the coding modes. In this instance, the used frequency may be calculated using a single previous video, immediately before the current video, or N previous videos before the current video. Here, N may be a constant.

In addition, the mode determination unit 190 may change a mode corresponding to the largest coding size of the current video or the coding size of the current video, using a used frequency of the coding mode and a reference frequency set in advance. That is, the mode determination unit 190 may change the largest coding size of the current video or the smallest coding size of the current video.

For example, when the largest coding size of a Super Macro Block (SMB) is

32×32, a coding may be performed in a unit of 32×32 in a Group of Picture (GOP). In this instance, the mode determination unit 190 may calculate a used frequency in which 32×32 is generated with respect to the GOP in a vertical and horizontal direction by four.

When the calculated used frequency is equal to or more than the reference frequency, the mode determination unit 190 may change the largest coding size from 32×32 to 64×64. That is, the mode determination unit 190 may change the coding mode so that coding is performed in a unit of 64×64 in the next GOP. In this instance, the mode determination unit 190 may count the used frequency in a frame unit, using statistics for each frame and slice type, in a slice unit, and a predetermined macro block unit number other than the GOP.

Conversely, when the largest coding size of the SMB is 64×64, the mode determination unit 190 may change the largest coding size from 64×64 to 32×32 in a case where the calculated used frequency is less than the reference frequency. Thus, in the next GOP, coding may be performed using only up to an SMB of 32×32.

In this instance, since the largest coding size of the SMB may be a concept corresponding to the Largest Coding Unit (LCU) in a scheme using a Coding Tree Block (CTB), the largest coding size of the SMB may be easily applied even to a scheme using CTB. Here, a scheme of changing a size of the LCU may be applied even to changing of the smallest coding unit size. Since a process of changing the smallest coding unit size may be similar to a scheme of changing a size of the LCU and thus, detailed description thereof will be omitted.

In addition, the scheme of changing the size of the coding unit may be applied even to a scheme of changing a size of the transformation. In this instance, a process of changing the size of the transformation may be similar to the scheme of changing the size of the LCU and thus, detailed descriptions thereof will be omitted.

Meanwhile, the mode determination unit 190 may change the coding mode by the structure of the instruction in the similar manner to that of the filter list control unit 170. That is, the mode determination unit 190 may add, delete, and change the coding mode by the structure of the instruction.

For example, the mode determination unit 190 may add the coding mode by the structure of the instruction shown in the following Table 5.

TABLE 5

| | | |
|---|---|---|
| 4 (addition) | 1 (SMB) | 1 or 2 |

In Table 5, 4 of a first column denotes addition of a coding mode, 1 of a second column denotes that a coding unit is an SMB, 1 of a third column denotes a case where the largest coding size is 32×32, and 2 of the third column denotes a case where the largest coding size is 64×64.

In addition, the mode determination unit 190 may determine a detailed method for each coding mode using coding information of the previous video.

For example, in a case of an intercoding mode, the mode determination unit 190 may selectively apply a transformation of 4×4 or 8×8 in a coding unit. In this instance, the mode determination unit 190 may calculate use statistics when each of the transformations is performed, and determine whether to apply the calculated use statistics to the next coding.

For example, when a used frequency of the transformation of 8×8 is less than the reference frequency determined in advance, the mode determination unit 190 may transmit an instruction to instruct not to use the transformation of 8×8 for the next statistic processing unit. Next, in the coding unit, information used for displaying whether the transformation of 8×8 or the transformation of 4×4 is used may be omitted. Thus, a coding efficient may be improved.

For another example, when the largest coding unit size and the smallest coding unit size are determined using a CTB such as high efficiency video coding (HEVC), a range of the coding unit size used in the coding may be designated using depth information (CTB depth) and 2 information. Here, the depth information denotes a range of the largest to the smallest in the largest coding unit size. Even using the above described tree structure, the coding device may determine whether to increase or reduce the largest coding unit size in accordance with a used frequency of the largest coding unit. In addition, the coding device may measure the used frequency of the smallest coding unit, and determine whether to increase or reduce the smallest coding unit size.

The determined information may be transmitted to the mode determination unit as an instruction, and an example of the instruction is shown in the following Table 6.

TABLE 6

| | | |
|---|---|---|
| 5 (largest size) | 0 (increase in | If (existing only when |
| Or 6 (smallest size) | one unit) | a first row is 7) |
| Or 7 (change in both | Or 1 (reduction | 0 (increase in one unit) |
| largest size and | in one unit) | Or 1 (reduction in one |
| smallest size) | | unit) |

In table 6, a first value of an instruction denotes a meaning of the instruction. In this instance, when the first value of the instruction is 5, it denotes a change in the largest coding unit size, when the first value of the instruction is 6, it denotes a change in the smallest coding unit size, and when the first value of the instruction is 7, it denotes a change in both the largest coding unit size and the smallest coding unit size. In addition, a second value of the instruction denotes a type of the change. In this instance, when the second value of the instruction is 0, it denotes an increase of one unit, and when the second value of the instruction is 1, it denotes a reduction of one unit. Here, since the size of the coding unit has a value exponentially corresponding to 2, the increase of one unit denotes a change from a current size to a doubled size, and the reduction in one unit denotes a change from the current size to a halved size.

In table 6, a third value of the instruction may be a value used only when the first value of the instruction is 7. That is, the third value of the instruction may be a value used only when simultaneously changing the largest size and the smallest size of the coding unit. In this manner, when simultaneously changing the largest size and the smallest size of the coding unit, the second value of the instruction may be used to transmit the change in the largest size of the coding unit, and the third value of the instruction may be used to transmit the change in the smallest size of the coding unit.

The information transmission between the coding device and the decoding device with respect to the change in the mode information may be performed in the above described instruction type, or in a scheme of transmitting, to a picture or slice header, the largest coding unit size and depth information (CU depth) which clearly shows the changed mode information. Here, the mode information may include at least one of a change in the largest coding unit size, a change in the smallest coding unit size, a change in the largest transformation size, and a change in the smallest transformation size.

FIG. 3 is a flowchart illustrating a method of managing a filter list in a video coding device according to an embodiment of the present invention. In FIG. 3, since functions of the interpolation filter list control unit 171 and of the loop filter list control unit 173 are practically the same, the interpolation filter list control unit 171 and the loop list control unit 173 may be called the filter list control unit 170, which will be later described in detail.

Referring to FIG. 3, in operation 310, the filter determination unit 160 may determine an adaptive filter corresponding to a current video. Here, the adaptive filter may include an interpolation filter and a loop filter.

More specifically, the interpolation filter 161 may determine an adaptive interpolation filter corresponding to the current video. The loop filter 163 may determine an adaptive loop filter corresponding to the current video.

Next, in operation 220, the filter list control unit 170 may compare similarity between the adaptive filters corresponding to the current video and existing filters included in a filter list. In this instance, the filter list control unit 170 may compare the similarity using an inner product between the adaptive filter corresponding to the current video and the existing filters, a Euclidean distance, a primary norm, a secondary norm, and the like.

More specifically, the interpolation filter list control unit 171 may compare similarity between the adaptive interpolation filter corresponding to the current video and the existing interpolation filters included in the interpolation filter list.

Similarly, the loop filter list control unit may compare similarity between an adaptive loop filter corresponding to the current video and existing loop filters included in a loop filter list. Here, a technique of comparing the similarity between the adaptive interpolation or loop filter corresponding to the current video and the existing interpolation or loop filter has been already described in FIG. 1 and thus further descriptions thereof will be omitted.

When the determined adaptive filter is not similar to the existing adaptive filter in a NO branch of S230, the filter list control unit 170 may delete any one of the existing adaptive filters included in the filter list in operation S240. In this instance, the filter list control unit 170 may delete any one existing adaptive filter from the filter list using an FIFO scheme or based on a used frequency of each of the existing adaptive filters.

In this instance, when a fixed filter defined before the coding exists in the filter list, the fixed filters may be excluded from a target to be deleted from the filter list. That is, the fixed filters may always exist in the filter list, and the above described deletion processing may be performed by determining whether to delete only the adaptive filter.

When the coding is performed using the fixed filter, the filter list may include information indicating whether a filter existing in the filter list is a fixed filter defined in advance or the adaptive filter generated in the coding process.

In operation S250, the filter list control unit 170 may add, to the filter list, the adaptive filter corresponding to the current video. That is, the adaptive filter determined in operation S210 may be added to the filter list.

In addition, when the determined adaptive filter is similar to the existing adaptive filter included in the filter list in a YES branch of S230, the filter list control unit 170 may determine that characteristics of the determined adaptive filter are similar to those of the existing adaptive filter. Thus, it is necessary that the determined adaptive filter is added to the filter list.

Subsequently, in operation S280, the adaptive filter 180 may code the current video using the adaptive filters included in the filter list. Here, the adaptive filter may include an interpolation filter and a loop filter. Thus, the current video may be coded through the adaptive interpolation filters included in the interpolation filter list or the loop filters included in the loop filter list.

In this instance, the adaptive filter 180 may or may not code the current video using the adaptive filter corresponding to the current video depending on whether a double pass coding of the current video or a single pass coding of the current video is set.

More specifically, when the adaptive filter determined in operation S230 and the existing adaptive filter are not similar to each other, and the double pass coding is set in the current video, the current video may be coded using the existing adaptive filters included in the filter and the adaptive filter determined in operation S210.

In addition, when the adaptive filter determined in operation S230 and the existing adaptive filter are not similar to each other, and the single pass coding is set in the current video, the current video may be coded using the existing adaptive filters included in the filter list.

In this instance, the adaptive filter determined in operation S210 is not added to the filter list. Thus, after the coding of the current video is performed, the filter list control unit 170 may add the adaptive filter corresponding to the current video to the filter list so as to be used for coding the next video.

Filter list information including a type of the adaptive filter, used for coding the current video, corresponding to the current video determined through the coding device and method of FIGS. 1 to 3, a type of the instruction, information indicating whether the filter list is changed, and the like may be added to a bit stream to be transmitted to a decoding device.

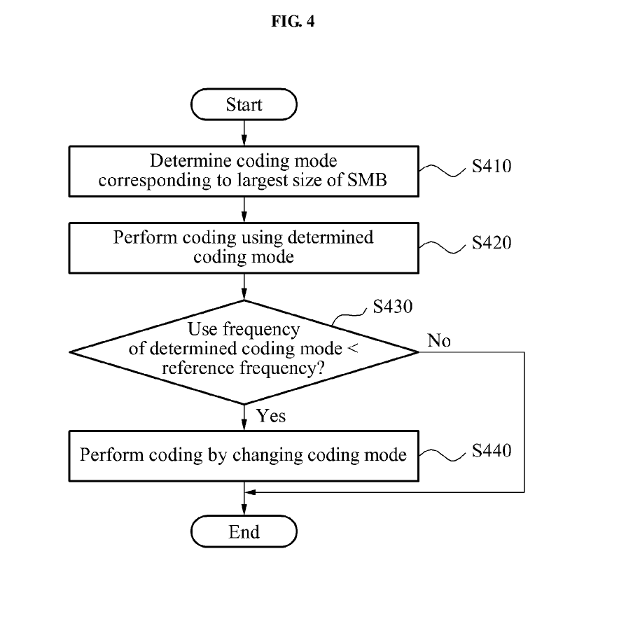

FIG. 4 is a flowchart illustrating a method of determining a mode in a video coding device according to an embodiment of the present invention.

Referring to FIG. 4, in operation S410, the mode determination unit 190 may determine a mode corresponding to the largest size of an SMB as a coding mode using coding information of the previous video. For example, the coding information of the previous video may include a used frequency of the coding mode.

Thus, in operation 420, the current video may be coded in the determined coding mode. Next, when a used frequency of the coding mode is less than a reference frequency in a YES branch of operation S430, the mode determination unit 190 may change the coding mode in operation S440. Thus, the current video may be coded to have the largest coding block size corresponding to the changed coding mode. In this instance, mode information indicating the coding mode may be added to a bit stream to be transmitted to a decoding device.

In addition, when the used frequency of the coding mode is equal to or more than the reference frequency set in advance in a No branch of operation S430, it is necessary that the mode determination unit 190 changes the coding mode.

As described above, the coding device and method of managing the adaptive filters have been described in detail; however, the decoding device may be managed through a list corresponding to each of an interpolation filter and a loop filter.

For example, the decoding device may add or delete the adaptive filter corresponding to the current video from the filter list using filter list information received from the coding device, or change an index.

In addition, the decoding device may decode the current video to have a decoding block size corresponding to the mode information received from the coding device.

In this instance, since a filter determination process is absent in the decoding process, in the decoding device 300, operations of managing an interpolation filter list and a loop filter list may be performed by only the filter list control unit. In this instance, a filter list control operation of the decoding device may be practically the same as that of the coding device, and an operation of performing decoding using the mode information in the decoding device may be practically the same as an operation of performing coding on the current video using the coding mode. Thus, the repeated descriptions thereof will be omitted.

In addition, the decoding device may control a filter list in accordance with a filter management instruction. Thus, it is not necessary that the decoding device include the filter determination unit of the coding device. That is, the filter management instruction may include contents corresponding to results determined in the filter determination unit of the coding device.

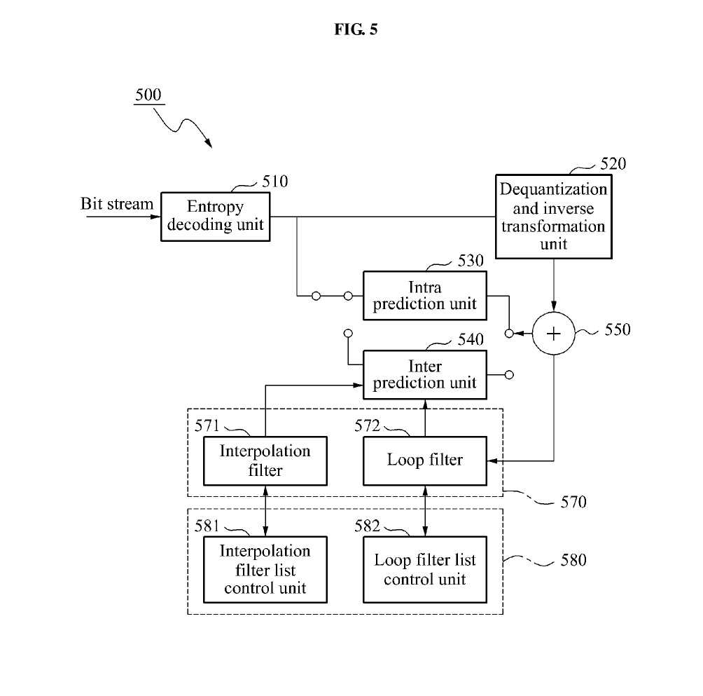

FIG. 5 illustrates a configuration of a video decoding device 500 according to an embodiment of the present invention.

Referring to FIG. 5, the decoding device 500 may include an entropy decoding unit 510, a dequantization and inverse transformation unit 520, an intra prediction unit 530, an inter prediction unit 540, an adding unit 550, a filter list control unit 560, and an adaptive filter 570.

The entropy decoding unit 510 may perform entropy decoding on a bit stream, and extract a transformation coefficient, a motion vector, filter list information, and mode information.

Here, the mode information may include a decoding mode, corresponding to the coding mode determined or changed in a frame unit, in a GOP unit, in a slice unit, or a macro block unit with respect to the current video.

In addition, the filter list information may include a type of the adaptive filter corresponding to the current video and change information of the filter list.

In this instance, the change information of the filter list may include information indicating whether the adaptive filter corresponding to the current video is added to the filter list, information indicating whether at least one of the adaptive filters included in the filter list is deleted, or information indicating whether the adaptive filter included in the filter list is changed.

The dequantization and inverse transformation unit 320 may dequantize the extracted transformation coefficient, and perform a discrete cosine inverse transform on the dequantized transformation coefficient to thereby obtain a difference block. In this instance, the dequantization and inverse transformation unit 320 may perform different dequantization with respect to each of coding units included in an input video or sub blocks.

In this instance, the dequantization and inverse transformation unit 320 may enable dequantization information indicating a type of the dequantization performed on the difference block to be included in the dequantized bit stream to thereby outputted.

Here, the type of the dequantization may include a frequency domain scalar dequantization, a space domain scalar dequantization, a frequency domain vector dequantization, and a space domain vector dequantization. In addition, the dequantization information may be included in the bit stream in a flag bit type or an index type. In this instance, a process of determining a type of the dequantization in accordance with the dequantization information may be the same as that of the video coding device 100 and thus, detailed descriptions thereof will be omitted.

The intra prediction unit may predict a macro block to be decoded using a pixel value of a spatially neighboring pixel so as to code a block of the video on which the entropy decoding is performed, and decode the predicted macro block.

The inter prediction unit 540 may generate a prediction block, of a current block using the motion vector extracted in the entropy decoding unit 510.

The adding unit 550 may restore the current block in addition to the difference block obtained in the dequantization and inverse transformation unit 520 and the prediction block. In this instance, the prediction block may be transmitted from the intra prediction unit 530 or the inter prediction unit 540 to the adding unit 550.

The filter list control unit 560 may include an interpolation filter list control unit 581 and a loop filter list control unit 582.

When the adaptive filter corresponding to the current video included in the filter list information extracted in the entropy decoding unit 510 is the interpolation filter, the interpolation filter list control unit 581 may add the adaptive interpolation filter corresponding to the current video to the interpolation filter list.

In this instance, the interpolation filter list control unit 581 may compare similarity between the adaptive filter corresponding to the current video and existing filters included in the filter list.

For example, the interpolation filter list control unit 581 may compare the similarity between the adaptive filter corresponding to the current video and the existing filters, using an inner product between the adaptive filter corresponding to the current video and the existing filters, a Euclidean distance, a primary norm, a secondary norm, and the like. Here, the comparison of similarity has already been described in the coding device and thus detailed descriptions will be omitted.

When the adaptive filter corresponding to the current video is not similar to the existing adaptive filters, the interpolation filter list control unit 581 may add the adaptive interpolation filter corresponding to the current video to the interpolation filter list.

In this instance, the interpolation filter list control unit 581 may delete any one of the existing adaptive interpolation filters from the interpolation filter list using a used frequency of each of the existing adaptive filters and an FIFO scheme. After deleting the existing adaptive interpolation filter, the adaptive filter corresponding to the current video may be added to the interpolation filter list.

When the adaptive filter corresponding to the current video included in the filter list extracted in the entropy decoding unit 510 is a loop filter, the loop filter list control unit 562 may add the adaptive loop filter corresponding to the current video to the loop filter list. In this instance, a process of adding the adaptive loop filter corresponding to the current video to the loop filter list, or a process of deleting the existing adaptive loop filter may be the same as those in the interpolation filter list control unit 561 and thus further descriptions thereof will be omitted.

The adaptive filter 570 may include an interpolation filter 571 and a loop filter 572.

Here, the interpolation filter and the loop filter of the decoding device may be practically the same as those of coding device and thus, detailed descriptions thereof will be omitted.

The interpolation filter 571 may decode the current video using the adaptive or fixed interpolation filters included in the interpolation filter list.

For example, when the current video is coded in more than two passes, and the adaptive interpolation filter obtained from the current video is added to the filter list to be used for coding the current video, the coding device may enable an instruction to be included in the bit stream to be transmitted to the decoding device so that a new adaptive filter before the coding of the current video is registered in the interpolation filter list. Accordingly, the decoding device may register, in the interpolation filter list, the new adaptive interpolation filter determined with respect to the current video by interpreting the instruction included in the bit stream. Thereafter, the decoding device may decode the current video using the changed interpolation filter list.

For another example, when the current video is coded in a single pass, and a filter addition is determined to be performed since the adaptive interpolation filter obtained from the current video differs from the existing filter, the adaptive interpolation filter obtained from the current video may be added to the filter list to be used for coding the next video. Thus, a current video stream exists in the bit stream, and then a filter addition instruction may be added to the bit stream. In this instance, the decoding device may perform decoding on the current video in a state where the adaptive interpolation filter of the current video obtained from the coding device is not added to the filter list. Next, the decoding device may interpret the filter addition instruction for the next video, and process the interpreted instruction.

The decoding process, unlike the coding process, may not be significantly changed depending on the single pass and the double pass; however, there is a difference between the decoding process and the coding process only in that a filter addition to the filter list is performed before or after decoding the current video. This may be processed by enabling the filter addition instruction to be included before or after the current video stream in the bit stream.

When a single pass decoding is set in the current video, the interpolation filter 571 may decode the current video using the existing interpolation filters included in the interpolation filter list before the adaptive interpolation filter corresponding to the current video is added to the interpolation filter list. In this instance, the next video may be decoded using the interpolation filter list after the adaptive interpolation filter corresponding to the current video is added to the interpolation filter list.

In this instance, when decoding the current video, the current video may be decoded in a decoding size unit corresponding to mode information. For example, as the decoding size unit, a frame unit, a GOP unit, a slice unit, a coding unit, or the like may be used.

The loop filter 572 may decode the current video using the adaptive loop filters included in the loop filter list. Here, the a process of decoding the current video through a loop filtering may be practically the same as a process of decoding the current video by performing interpolation filtering except for a type of the filter and thus, detailed descriptions thereof will be omitted.

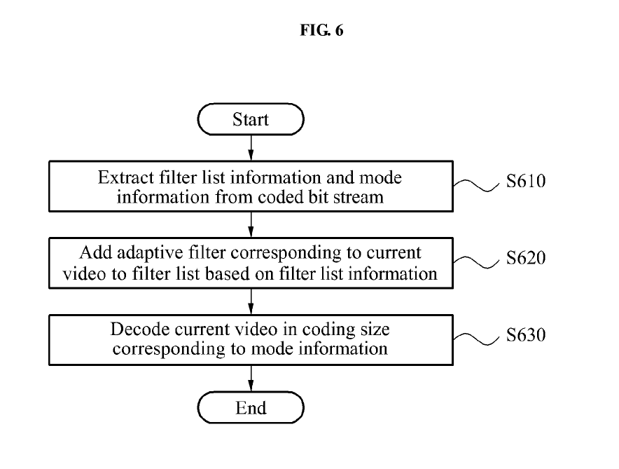

FIG. 6 is a flowchart illustrating a video decoding method according to an embodiment of the present invention.

In operation 610, the decoding device may extract filter list information and mode information from the bit stream received from the coding device. Here, the bit stream may be video coded by the coding device. The mode information may be information indicating a coding mode of the current video.

In addition, the filter list information may include a type of the adaptive filter used for coding the current video, information indicating change information of the filter list, and the like.

For example, the change information of the filter list may include information indicating whether the adaptive filter corresponding to the current video is added to the filter list, information indicating whether the existing adaptive filters included in the filter list are deleted, information indicating whether an index of each of the adaptive filters included in the filter list is changed, and the like.

In operation S620, the decoding device may add the adaptive filter corresponding to the current video to the filter list based on the extracted filter list information. Here, the adaptive filter may include an adaptive interpolation filter and an adaptive loop filter. Similarly, the filter list may include an interpolation filter list and a loop filter list.

For example, when the adaptive filter corresponding to the current video is added to the filter list in the coding device based on the filter list information, the decoding device may add the adaptive filter corresponding to the current video to the filter list.

In this instance, when the current video is coded using the adaptive filter corresponding to the current video and the existing filters in the coding device, the decoding device may decode the current video using the adaptive filter corresponding to the current video and the existing filters.

Similarly, when the current video is coded only using the existing adaptive or fixed filters in the coding device, the decoding device may decode the current video using the existing filters.

In this instance, in operation S630, the decoding device may decode the current video to a decoding size corresponding to the mode information. That is, the current video may be decoded in the largest decoding size corresponding to the largest coding size determined in the coding device.

For example, when an instruction to decode the largest coding block size in a unit of 32×32 is included in the mode information without using the transformation of 8×8, the decoding device may interpret that a transformation flag of 8×8 is absent when interpreting a header of each mode. In addition, the decoding device may interpret that a header of a coding unit layer of 64×64 is absent, and interpret the headers starting from the coding unit layer of 32×32 to thereby perform decoding.

As described above, the filter list control unit 170 separately manages the filter list corresponding to each of the sub pixel; however, this is merely an example, and may manage the smaller numbered-filter lists than a number of the sub pixels using symmetrical properties of the sub pixels.

For example, referring to FIG. 2, the same filter may be used in each of sub pixels a and c, sub pixels d and 1, sub pixels e and o, sub pixels g and m, sub pixels i and k, and sub pixels f and n which are symmetrical to each other. Accordingly, the filer list control unit 170 may manage 7 filter lists instead of 15 filter lists.

In addition, as described above, deletion of any one of the existing adaptive filters included in the filter list has been described; however, this is merely an example for convenience of description. Thus, the filter list control unit 170 may delete at least one of the existing adaptive filters from the filter list.

In addition, as described above, performing of the descending order alignment by allocating the lower index to the adaptive filter having the larger used frequency has been described; however, this is merely an example for convenience of description. Thus, the filter list control unit 170 may align the adaptive filters included in the filter list in the ascending order or the descending order based on the used frequency.

In addition, as described above, managing the filter list or determining the mode using the adaptive filter or a used frequency for each mode has been described; however, this is merely an example for convenience of description. Thus, the filter list may be managed or the mode may be determined using statistics of the adaptive filer or statistics for each mode.

Even though the coding device does not transmit the mode information other than transmitting the mode information while the mode information is included in the bit stream in an instruction type, the decoding device may infer whether the mode is changed. That is, the decoding device may perform the mode determination process performed in the coding device in the same manner, thereby inferring whether the mode is changed.

As described above, an example in which the video coding method and device performs the DCT has been described; however, the video coding method and device may use other different transformation schemes other than the DCT.

In this instance, it does not affect effects of the invention even though a different transformation scheme is used in the video coding method and device.

Similarly, an example in which the video decoding method and device performs the IDCT has been described; however, the video coding method and device may use other different transformation scheme other than the IDCT. In this instance, it does not affect effects of the invention even though a different transformation scheme is used in the video coding method and device.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A video coding method, comprising:
determining an adaptive filter corresponding to a current video;
comparing the determined adaptive filter and at least one of an existing adaptive filter included in a filter manager;
determining whether to add the determined adaptive filter to the filter manager based on the compared result; and
coding the current video using the adaptive filter included in the filter manager.

2. The video coding method of claim 1, wherein a structure of an instruction of the filter manager includes a type of the instruction to control the determined adaptive filter, a target filter manager, and filter information, the adaptive filter includes at least one of an adaptive interpolation filter and an adaptive loop filter, and the adaptive filter manager includes at least one of an adaptive interpolation filter manager and an adaptive loop filter manager.

3. The video coding method of claim 2, wherein the type of the instruction includes at least one of an instruction to add the determined adaptive filter to the filter manager, an instruction to delete at least one of the adaptive filters included in the filter manager, and an instruction to adjust an index of the adaptive filter included in the filter manager.

4. The video coding method of claim 1, wherein the comparing compares similarity between the determined adaptive filter and the existing filters using an inner product between the adaptive interpolation filter and the existing adaptive or fixed interpolation filters, a Euclidean distance, a primary norm, or a secondary norm.

5. The video coding method of claim 4, wherein the determining of whether to add the determined adaptive filter adds the determined adaptive filter to the filter manager when similarity between the determined adaptive filter and the existing filters does not exist.

6. The video coding method of claim 5, wherein the coding codes the current video using the adaptive filters included in the filter manager to which the determined adaptive filter is added when the current video is set as coding at least two passes.

7. The video coding method of claim 5, wherein the coding codes the current video using the existing filters included in the filter manager before the determined adaptive filter is added, when the current video is set as a single pass coding, and codes a next video using the adaptive filters included in the filter manager to which the determined adaptive filter is added.

8. The video coding method of claim 4, wherein the determining of whether to add the determined adaptive filter deletes the adaptive filter among the existing filters from the filter manager using a used frequency of each of the adaptive filters among the existing filters or a First In First Out (FIFO) scheme when the similarity between the determined adaptive filter and the existing filters does not exist, and codes the current video using the existing adaptive filters included in the filter manager when the similarity between the determined adaptive filter and the existing filters exists.

9. The video coding method of claim 1, further comprising:
allocating, to each of the filters, an index indicating a used frequency of the filters included in the filter manager; and
arranging the filters based on the allocated index.

10. A video coding method, comprising:
determining an adaptive filter corresponding to a current video;
comparing the determined adaptive filter and at least one of an existing adaptive filter included in a filter manager;
determining whether to add the determined adaptive filter to the filter manager based on the compared result;
coding the current video using the adaptive filter included in the filter manager; and
determining a coding mode of the current video using coding information of a previous video,
wherein the coding information of the previous video includes at least one of a change in the largest coding unit size to be used in the coding of the current video, a change in the smallest coding unit size to be used in the coding of the current video, a change in the largest transforming size to be used in the coding of the current video, and a change in the smallest transforming size to be used in the coding of the current video.

11. The video coding device of claim 10, further comprising:
determining the coding mode of the current video using a used frequency of a coding mode of a plurality of previous videos.

12. The video coding method of claim 10, further comprising:
transmitting the coding mode of the current video in a type of an instruction, or inserting the coding mode of the current video to a picture or a slice header to transmit the inserted coding mode.

13. A video coding device, comprising:
a filter determination unit to determine an adaptive filter corresponding to a current video;
a filter manager control unit to compare similarity between the determined adaptive filter and at least one of an existing adaptive filter included in a filter manager to determine whether to add the determined adaptive filter to the filter manager;
an adaptive filter to code the current video using the adaptive filter included in the filter manager; and
a mode determination unit to determine a mode corresponding to a coding size of the current video using filter information of a previous video.

14. The video coding device of claim 13, wherein:
the filter manager control unit includes an interpolation filter manager control unit to determine whether to add an interpolation filter to an interpolation filter manager when the adaptive filter corresponding to the current video is the interpolation filter, and a loop filter manager control unit to determine whether to add a loop filter to a loop filter manger when the adaptive filter corresponding to the current video is the loop filter, and
the adaptive filter includes an adaptive interpolation filter to perform an adaptive interpolation filtering with respect to the current video, and an adaptive loop filter to perform an adaptive loop filtering with respect to the current video.

15. A video decoding method, comprising:
extracting filter manger information from a bit stream in which a video coding is performed; and
adding an adaptive filter corresponding to a current video to a filter manager based on the filter manger information,
wherein the filter manager information includes a type of the adaptive filter corresponding to the current video and change information of the filter manager.

16. The video decoding method of claim 15, wherein:
the change information of the filter manger includes information indicating that a new adaptive filter is added to the filter manager, information indicating that at least one of the adaptive filters included in the filter manager is deleted, or information indicating that an index of the adaptive filter included in the filter manager is changed,
the adaptive filter includes at least one of an adaptive interpolation filter and an adaptive loop filter, and the filter manager, and the filter manager includes at least one of an adaptive interpolation filter manager and an adaptive loop filter manager.

17. The video decoding method of claim 15, further comprising:
deleting an existing adaptive filter from the filter manager using a used frequency of each of the existing adaptive filters or an FIFO scheme; and
decoding the current video using the filters included in the filter manager,
wherein the adding of the adaptive filter adds the adaptive filter corresponding to the current video to the filter manager after deleting the adaptive filter from the filter manager.

18. A video decoding method, comprising:
extracting mode information with respect to a current video from a bit stream in which a video coding is performed; and
decoding the current video in a coding size corresponding to the mode information,
wherein the mode information includes at least one of a change in the largest coding unit size, a change in the smallest coding unit size, a change in the largest transforming size, and a change in the smallest transforming size.

19. The video decoding method of claim 18, wherein the extracting receives the mode information with respect to the current video in a type of an instruction, or extracts the mode information with respect to the current video inserted to a picture or a slice header.

20. The video decoding method of claim 18, wherein the mode information includes a coding size determined or changed in a frame unit with respect to the current video, in a Group of picture (GOP) slice, or a macro block unit.
